(19) United States
(12) Patent Application Publication
(10) Pub. No.: US 2014/0361002 A1
(43) Pub. Date: Dec. 11, 2014

(54) Portable Heating Device For Liquid

(71) Applicant: Clinton Cable, El Cajon, CA (US)

(72) Inventor: Clinton Cable, El Cajon, CA (US)

(21) Appl. No.: 13/912,684

(22) Filed: Jun. 7, 2013

(51) Int. Cl. A47J 36/24

(52) U.S. Cl. CPC A47J 36/2472
USPC 219/435; 219/439

(57) ABSTRACT

A heating device for liquid to warm the liquid and keep the temperature for a longer period of time for the portable use of the cup has been invented. The heating device in the present invention comprises an electronically wired removable cup and a sleeve wherein said cup filled up with liquid is inserted for the heating purpose and the heating process starts through the electronic wires embedded in a heating cup when an electronic switch is activated. The heating elements embedded or equipped within a cup, not within the housing, in present invention keeps the liquid in a cup hot for a longer period of time, for the portable use of the cup. In addition, the electronic power through the cord can be activated or blocked out by a switch on the cord and the cord may also connects with automotive plug, to fit an electric cigarette lighter socket of a vehicle, for various portable use of the cup.

### RELATED APPLICATIONS

This application claims the benefit of priority to the United States Provisional Patent Application for “Portable Heating Device for Liquid,” Ser. No. 61/659,696, filed on Jun. 7, 2012, and currently co-pending, and the disclosure is incorporated fully herein by reference.

### FIELD OF THE INVENTION

The present invention pertains generally to a heating device for beverages. The present invention is more particularly, though not exclusively useful for the heating of beverages, such as coffee, tea, water, or soup, in a cup equipped with integral heating elements that heats a beverage merely by inserting the cup into the sleeve.

### BACKGROUND OF THE INVENTION

Resistive heating wires have been known since the discovery of electricity. Resistive heaters have been used throughout the years as a means to convert electrical current to heat. Often times, the generation of heat is an undesired by-product of passing high currents through electrical conductors such as in electrical transmission lines, and other times, the heating is an intentional result, such as in localized heating elements.

Early in the 19^{th} Century, Jean Peltier discovered the phenomena that became the basis of today's thermoelectric industry. Peltier learned that passing current through two dissimilar electrical conductors caused heat to be either emitted or absorbed at the junction of the materials. However, only after the mid-20^{th} Century, with advancements in semiconductor technology, did the practical applications for thermoelectric devices became feasible. As a result of this newfound feasibility, there has been an increasing number and variety of products adopting thermoelectric technology.

One of the principal challenges of keeping beverages at their proper serving temperature is the tendency for such beverages to assume the ambient temperature in the environment into which they have been placed. For instance, a hot beverage, such as coffee or tea, quickly cools when served in an uninsulated cup. In an effort to combat this tendency to cool, several active heat management systems have been developed. Some inventions adopted systems of a warming cup holder, providing an apparatus that is primarily developed for the purpose of keeping beverages hot. Other inventions disclose systems which include a cup that is inserted into a heated housing, or receiver, equipped with heating elements that heat the cup. However, the heating elements that are embedded within the housing do not directly heat the liquid within the cup. Moreover, the heating elements must first heat the cup before heating the beverages thus making the cup hot to the touch which, when used in a motor vehicle, can result in dangerous burns to the driver or vehicle occupants.

Another deficiency with existing devices is the inability to maintain the hot temperature of the liquid for an extended period of time when the cup is removed from the housing after being heated. In fact, since the heating elements are not within the cup itself, once removed from the receiver, there is no more heat imparted to the beverage.

In light of the above, it would be advantageous to provide a portable heating device for liquids which enables the cup to maintain the consistently hot temperature of liquid wherein even after the cup is removed from the housing. It would further be advantageous to provide a portable heating device for liquids where the heating elements are embedded within the cup to directly heat the beverage containing surfaces. It would also be advantageous to provide a portable heating device for liquids that maintain the increased temperature of the beverage in a cup hot for an extended time.

### SUMMARY OF THE INVENTION

The portable heating device for liquids of the present invention includes a heating device having an electronically wired removable cup and a receiver sleeve to receive the cup filled with a beverage for heating. The heating process starts through the electronic heating wires embedded in the heating cup when an electronic switch is activated to pass current through the electronic heating wires. The present invention provides a heating device for liquid where the heating elements are embedded within the cup itself, not within the housing, to more efficiently heat the liquid within the cup, and to keep the liquid in the cup hot for a longer time.

In addition, the portable heating device for liquids is powered through an electronic power cord, which may be equipped with a fuse or switch, and in a preferred embodiment, may be inserted into an automotive plug for 12 Volts DC, such as from an electric cigarette lighter socket of a vehicle.

A timer circuit can be included to provide a maximum period of heating, and may also be equipped with a thermal regulation device, such as a thermistor or temperature sensor that ensures that the contents within the cup are not heated to a level that would be dangerous for human consumption.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a diagrammatic view illustrating a preferred embodiment of a heating device in the present invention showing the receiver having a power cord equipped with an automotive 12 VDC plug, and having an ON/OFF switch used to start the heating process, and a removable cup insertable to be closely received into the receiver; and

FIG. 2 is a cross-sectional view of a heating device of the present invention taken along lines 2-2 of FIG. 1, and showing the placement of the heating wires within the cup assembly between the outer housing and the inner beverage container, and having a pair of electrical connections integral to the cup that engage corresponding electrical contacts in the receiver to make a circuit to allow the flow of electrical current from the power input wire through the receiver to the heating elements within the cup.

### DETAILED DESCRIPTION OF THE INVENTION

### Removable Heating Device for Liquid

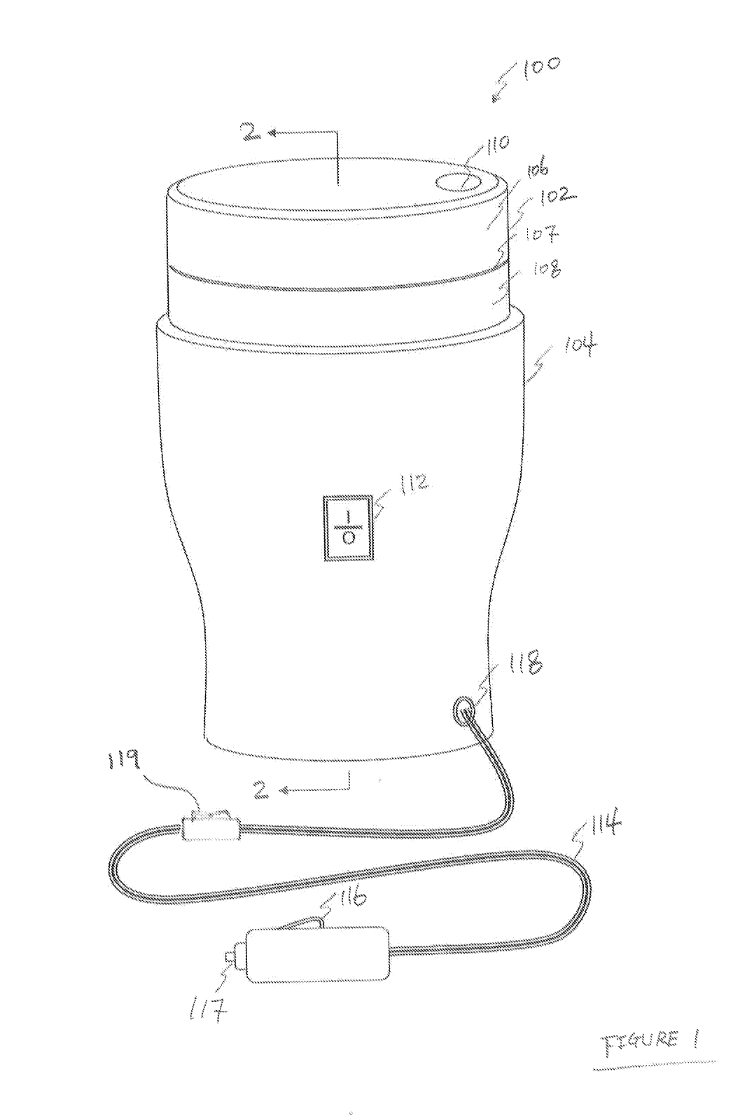

Referring initially to FIG. 1, a preferred embodiment the portable heating device for liquids of the present invention is shown and generally designated 100. Portable heating device 100 includes a heating cup 102 and a heating sleeve, or receiver, 104. Heating cup 102 is designed for holding a beverage therein. Beverage, as used herein, is intended to include but not be limited to, liquid beverages such as coffee, tea, and hot chocolate, as well as soups, or other food products requiring a container for consumption and suitable for heating.

Heating cup 102 includes an upper portion 106 functioning as a lid that can be opened and closed along the line 107, and a main body 108 of a cup 102 into which liquid will be poured. The upper portion 106 functions as a lid to cover the open top of the cup 102. The lid 106 is designed for keeping the contents of the cup 102 warm and for preventing spillage of the contents from the cup 102. The upper portion 106 also has an opening 110 which enables the user to sip or pour out the liquid.

Heating cup 102 is removably insertable into the heating sleeve, or receiver, 104 such that the cup 102 is held upright within the heating sleeve 104. Heating sleeve 104 may be made of materials with very low thermal conductivity having an open top and a closed base, an inner surface and an exposed outer surface. The thermally insulative properties of receiver 104 ensure that a fully heated cup 102 does not result in a heated sleeve 104. Indeed, the insulation of receiver 104 prevents the majority of heat generated by heating elements 120 in the cup 102 from being reachable by a user of the present invention.

Heating sleeve 104 is equipped with a switch 112 which turns on or off the entire system 100. Heating sleeve 104 is connected to power through the electronic power cord 114. Cord 114 exits power port 118 of sleeve 104 and terminates in a vehicle automotive plug having a conductor tip 117 and a side contact 116. A fuse (not shown) may be integrated into the automotive plug to provide over-current protection as is known in the art.

A switch 119 may be included in power cord 114 to provide an ON/OFF for the entire portable heating device 100. Heating device 100 in the present invention is provided with a direct current power supply (not shown) and is typically contemplated as a 12 volts direct current (12 VDC) such as the voltage supplied by a standard automobile. It is to be appreciated, however, that other voltages may be utilized herein without departing from the present invention. The plug 117 is preferably adapted to fit an electric cigarette lighter socket of a vehicle to electrically couple the heating elements to a power source.

It is an object of the present invention to actively maintain or increase the temperature of a beverage inserted into the heating sleeve 104. The heating sleeve 104 may be ideally made of the same heat-conductive material as the heating cup 102 to allow it to conform to the shape of the heating sleeve 104.

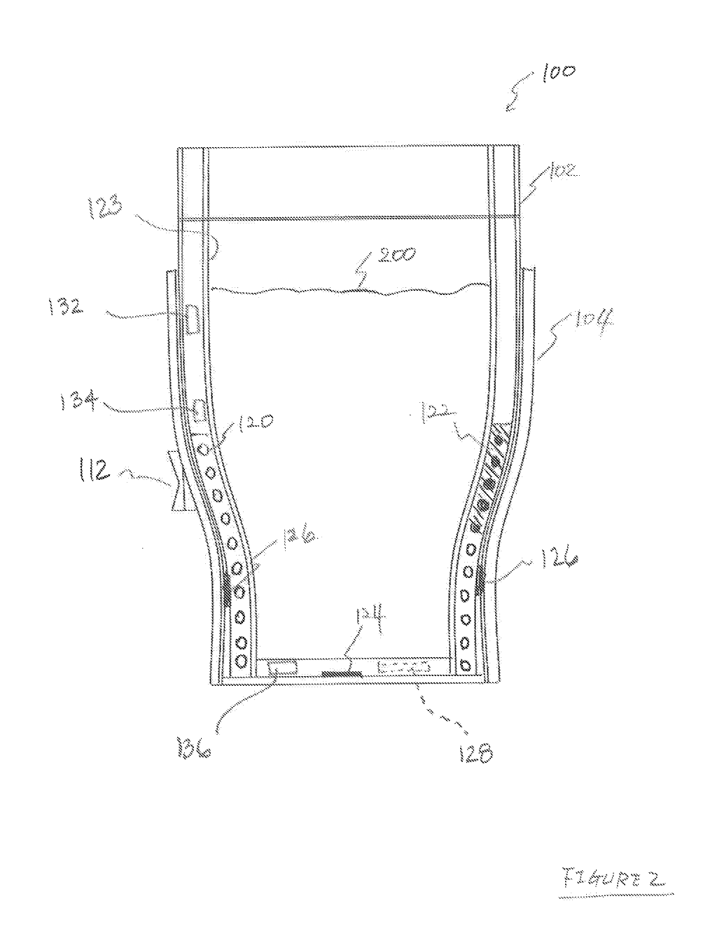

FIG. 2 depicts a cross section of a preferred embodiment of the portable heating device 100 of the present invention, cut along the line 2-2 of FIG. 1. A number of heating elements 120 are disposed within cup 102. In a preferred embodiment, heated cup 102 is equipped with electronic wires 120 embedded in a heat-conducting polymer fill 122.

In a preferred embodiment, a controller 128 may be integrated into the portable heating device 100. Referring back to FIG. 1, a controller may be integrated into cup 102 and in electrical connection with the heating elements 120 and the power source contacts 124 and 126 of FIG. 2.

Switch 112 is designed for selectively powering the heating element 120 and is also electrically coupled to the heating element 120. Once a cup 102 is inserted into a receiver 104 and switch 112 is turned on, voltage is applied to conductors 124 and 126 at the bottom and sides of cup 102, and creates a circuit with the heating elements 120 in heating cup 102. As current passes through the heating element 120, the heating element 120 heats to warm polymer 122 which is transmitted to the interior surface 123 of cup 102 thereby heating liquid 200. Once the interior surface 123 of cup 102 is within a suitable temperature range, controller 128 may adjust the current flow through heating element 120 to maintain the desired temperature.

Thermal sensing devices, such as thermistors 132, 134 and 136 may be integrated into cup 102. Specifically, thermistor 132 may be placed within the cup and adjacent to the upper portion of the fluid 200 within the cup 102, thermistor 134 may be placed adjacent the middle portion of the fluid 200 within the cup 102, and thermistor 136 may be placed against bottom or lower portion of the fluid 200 within the cup 102. As placed, the thermistors 132, 134 and 136 provide for different levels of sensing to ensure that the liquid within any portion of cup 102 is within permissible temperature ranges. For instance, if the sensor were only on the top of the cup 102, it may not accurately measure the temperature of a partially filled liquid within the lower portions of the cup.

A timer may be integrated into controller 128 to provide for an automatic shut-off for portable heating device 100. The controller 128 may be configurable or be preconfigured with a pre-determined delay, such as 30 minutes, to provide ample time for thorough heating of liquid 200 within cup 102. The delay times can vary depending on the application of the portable heating device 100

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Accordingly, while the present invention has been described herein in detail in relation to preferred embodiment, it is to be understood that this disclosure is only illustrative and exemplary of the present invention and is made merely for purposes of providing a full and enabling disclosure of the invention. Since numerous modifications and changes will readily occur to those skilled in the art, it is not desired to limit the invention to the exact construction and operation shown and described, and accordingly, all suitable adaptations, variations, modifications and equivalent arrangements may be resorted to, falling within the scope of the present invention.

What I claim is:

1. A portable heating device for liquid, comprising:
a cup;
a sleeve;
a power switch;
a power cord extending from said sleeve;
an electrical connector located at the end of said power cord;
a plurality of electrical contacts located on the inner surface of said sleeve;
a plurality of electrical contacts located on the outer surface of said cup;
one or more temperature sensors disposed within the cup; and
one or more heating elements disposed within the walls of said cup;
wherein said cup is removably insertable into said sleeve,
wherein said electrical contacts on said sleeve make electrical contact with said electrical contacts on said cup when said cup is inserted into said sleeve,
wherein said power switch is located on the outside of said sleeve or at a point along the length of said power cord,
wherein said portable heating device is powered from a direct current power source.

2. The portable heating device for liquid of claim 1, further comprising a removably attached lid.

3. The portable heating device for liquid of claim 2, wherein said lid further comprises an opening that allows liquid contents to be sipped or poured.

4. The portable heating device for liquid of claim 1, further comprising said heating elements embedded in a heat-conducting fill.

5. The portable heating device for liquid of claim 4, wherein said fill is a polymer based material.

6. The portable heating device for liquid of claim 1, further comprising a temperature controller in electrical connection with said heating element, said temperature sensors, and a power source.

7. The portable heating device for liquid of claim 6, further comprising one or more temperature sensors disposed within said cup and in communication with said temperature controller.

8. The portable heating device for liquid of claim 1, wherein said electrical connector is a vehicle automotive plug having a conductor tip and a side contact.

9. The portable heating device for liquid of claim 1, wherein said sleeve is made of a material with a low thermal conductivity,

10. The portable heating device for liquid of claim 1, wherein said portable heating device is powered from a 12 volt direct current supply.

11. The portable heating device for liquid of claim 1, further comprising a timer to control power to said device.

12. The portable heating device for liquid of claim 11, wherein said timer is user programmable.

13. The portable heating device for liquid of claim 11, wherein said timer is preconfigured with a pre-determined delay.

14. The portable heating device for liquid of claim 1, wherein said cup is held upright when inserted into said sleeve.

15. The portable heating device for liquid of claim 1, wherein said temperature sensors are thermistors.

16. The portable heating device for liquid of claim 1, wherein a plurality of said temperature sensors are located at different positions in said cup.
